(19) United States
(12) Patent Application Publication
(10) Pub. No.: US 2025/0045125 A1
(43) Pub. Date: Feb. 6, 2025

(54) APPLICATION PROGRAMMING INTERFACE SELECTION BASED ON SUSTAINABILITY

(71) Applicant: Cisco Technology, Inc., San Jose, CA (US)

(72) Inventors: Praveen Iyengar, Newark, CA (US); Alhad Shrikant Rajurwar, Pleasanton, CA (US); Tejasvi Kashyap, Mysore (IN); Rajendra Kumar Thirumurthi, Milpitas, CA (US)

(21) Appl. No.: 18/365,580

(22) Filed: Aug. 4, 2023

(51) Int. Cl. G06F 9/50; G06F 9/54

(52) U.S. Cl. CPC G06F 9/5083; G06F 9/547

(57) ABSTRACT

A method to generate sustainability metric for nodes that are configured to potentially execute a network function such as an application programming interface, and to use the sustainability metric to select one of the nodes to execute the network function. The method includes receiving sustainability information for a first node and a second node in a plurality of nodes configured to execute at least part of a predetermined network function, receiving sustainability information for a location at which the first node and the second node are respectively disposed, for a given workload to be executed by the predetermined network function, generating a sustainability metric for the first node and the second node, and selecting, based on the sustainability metric, one of the first node and the second node to execute the predetermined network function.

### TECHNICAL FIELD

The present disclosure relates to network operations, and more particularly to techniques to identify and select an Application Programming Interface (API) based on a sustainability metric of nodes that support execution of the API.

### BACKGROUND

An application or API (which might rely on multiple applications and nodes) often relies on different computing services, such as compute, memory, and data storage. A given workload for the application or API may be allocated across multiple logically and geographically dispersed nodes or locations. Selecting the nodes and/or locations for a given workload can be a challenging task.

### BRIEF DESCRIPTION OF THE DRAWINGS

FIG. 1 shows several nodes that might host API functionality, along with a server that hosts API sustainability rating logic and information sources upon which API sustainability rating logic might rely, according to an example embodiment.

FIG. 2 shows example data that may be used by API sustainability rating logic to generate an API sustainability metric for an API, according to an example embodiment.

FIG. 3 illustrates the use of a machine learning approach that API sustainability rating logic might employ to generate an API sustainability metric for an API, according to an example embodiment.

FIG. 4 is a flowchart illustrating a series of operations executed by API sustainability rating logic, according to an example embodiment.

FIG. 5 is a block diagram of a computing device that may be configured to execute API sustainability rating logic and perform the techniques described herein, according to an example embodiment.

### DETAILED DESCRIPTION

### Overview

A method to generate sustainability metric for nodes that are configured to potentially execute a network function such as an application programming interface, and to use the sustainability metric to select one of the nodes to execute the network function. The method includes receiving sustainability information for a first node and a second node in a plurality of nodes configured to execute at least part of a predetermined network function, receiving sustainability information for a location at which the first node and the second node are respectively disposed, for a given workload to be executed by the predetermined network function, generating a sustainability metric for the first node and the second node, and selecting, based on the sustainability metric, one of the first node and the second node to execute the predetermined network function.

In another embodiment, a device is provided. The device includes an interface configured to enable network communications, a memory, and one or more processors coupled to the interface and the memory, and configured to receive sustainability information for a first node and a second node in a plurality of nodes configured to execute at least part of a predetermined network function, receive sustainability information for a location at which the first node and the second node are respectively disposed, for a given workload to be executed by the predetermined network function, generate a sustainability metric for the first node and the second node, and select, based on the sustainability metric, one of the first node and the second node to execute the predetermined network function.

### Example Embodiments

The software ecosystem continues to move towards adopting an “API-first” approach for delivering services. This development has enabled services to be executed from varied cloud infrastructures. The embodiments described herein offer an approach to define a selection of nodes and geographic locations that can execute a given API. Such a selection might result in selecting services in both public cloud and private datacenters. In one embodiment, a user (customer) may be given options for choosing what nodes, locations, or datacenters might be selected to support the given API. Criteria for selecting which nodes, locations, or datacenters that might be used to execute the given API may be based on an aggregated API sustainability metric that itself is based on sustainability data associated with the nodes, locations, or datacenters.

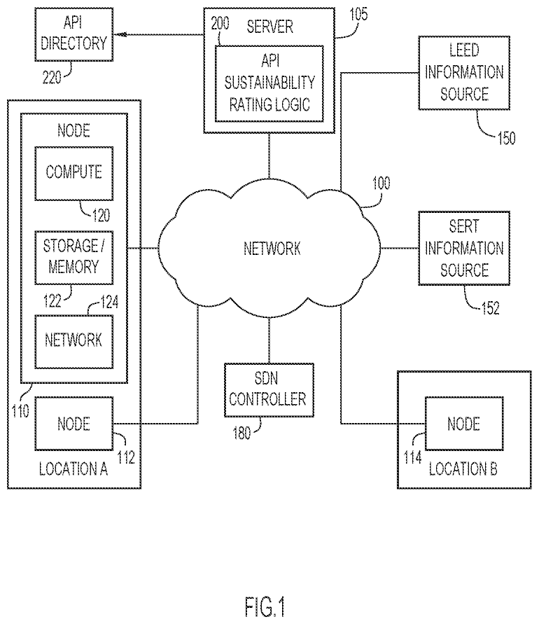

FIG. 1 shows several nodes that might host API functionality, along with a server 105 that hosts API sustainability rating logic 200 and information sources upon which API sustainability rating logic 200 might rely, according to an example embodiment. More specifically, the figure shows node 110, node 112, node 114, server 105, a Leadership in Energy and Environmental Design, or LEED information source 150, and a Server Efficiency Rating Tool, or SERT information source 152, all interconnected via a network 100. Node 110 and node 112 may be geographically disposed at a Location A, and node 114 may be geographically disposed at Location B. Network 100 may be a private network or public network, such as the Internet. Server 105 hosts API sustainability rating logic 200. The function of API sustainability rating logic 200 is to develop or generate an API sustainability metric for a given workload to be executed by an API. The API sustainability metric can then be used to help select which nodes and/or locations (and/or datacenters) should be used to execute the API. Selection may be a manual function, or may be performed automatically. In either case, the workload can be steered to selected nodes via, e.g., a software defined network (SDN) controller 180, or other component that can route the workload via the desired nodes to execute the functionality of the API.

Taking node 110 as an example, each node may have compute 120, storage/memory 122, and/or network 124 capabilities. Those skilled in the art will appreciate, however, that any given node might be configured to have more or less of any given one or more of these capabilities.

In accordance with an embodiment, API sustainability rating logic 200 is configured to derive an API sustainability metric for each API endpoint based on type of resources used for different workload types. For example, an AI/ML workload may be data and compute resource heavy, whereas a high-performance computing (HPC) workload may be compute and network resource heavy. API sustainability rating logic 200 may obtain information about the performance of each node from, e.g., SERT information source 152, which may ultimately be provided by vendors of a given node's equipment, and information about the power source and efficiency of each of Location A and Location B from LEED information source 150. API sustainability rating logic 200 may then derive one or more vectors to represent a given node from a sustainability perspective, use such vectors to generate a sustainability metric for each node, and then aggregate such metrics for an overall sustainability metric for the API.

The sustainability metric may be dynamic in nature as there can be multiple factors that can impact the overall efficiency of the system. API sustainability rating logic 200 may publish an API directory 220 that may comprise the following information:
Sustainability metric for the API
Sustainability savings for the API
API Provider

An API endpoint may be considered to be a collection of one or more operations that indirectly translate to a utilization of finite resources broadly classified as compute 120, storage/memory 122, and network 124. However, each of these resources can be further classified based on the specific requirements of the operation. These resources may be collectively represented as, e.g., networking switches, compute servers and storage servers, although, as shown in FIG. 1, a given node could host each of these services on a single node.

Each device or node may be rated based on power efficiency, and certified using, e.g., the SERT 2.0 framework. This dataset has been adopted as a standard for efficiency computation.

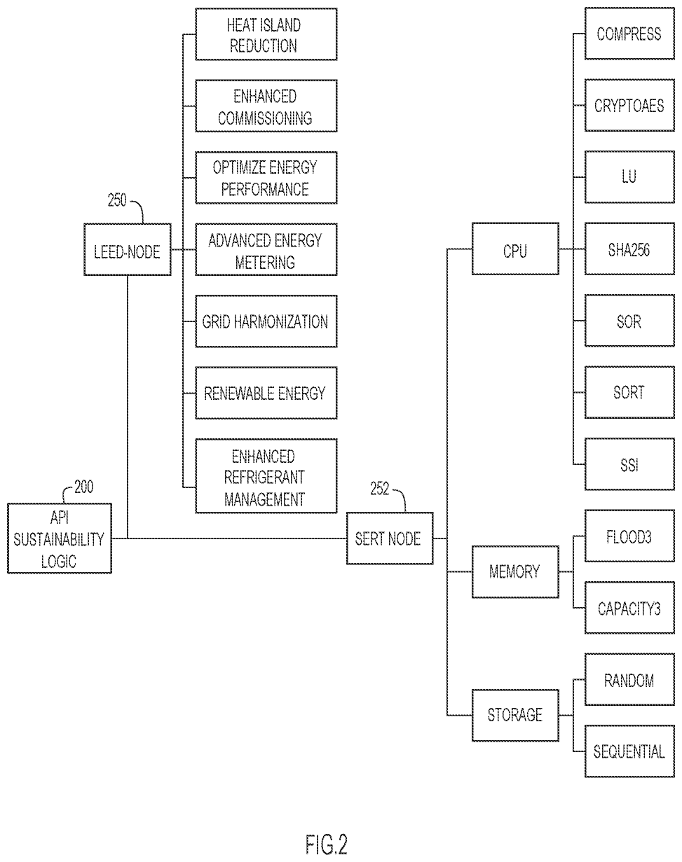

In this regard, FIG. 2 shows example SERT and LEED data that may be used by API sustainability rating logic 200 to generate an API sustainability metric for an API, according to an example embodiment. In this diagram, a LEED Node 250, which may correspond to LEED information source 150, collects numerical information regarding a location at which a given node is disposed. That information may include values representative of heat island reduction, enhanced commissioning, energy performance, advanced energy metering, grid harmonization, renewable energy, and enhanced refrigerant management, as well as, but not shown, location longitude, location latitude, and location ID. These values may be constant for a given location.

SERT Node 252, which may correspond to SERT information source 152, maintains a power efficiency score data for various specialized operations across compute, network and storage capabilities. The SERT data provides power efficiency score data at varied load intervals for individual pieces of equipment.

In accordance with an embodiment, this data is normalized and collected in a controlled environment by API sustainability rating logic 200. As such, API sustainability rating logic 200 can perform appropriate comparative analysis on respective nodes, even if the equipment operating at those respective nodes is provided by various third-party vendors.

In an embodiment, API sustainability rating logic 200 quantifies a personality of a given workload as input and, as an output, provides an API sustainability metric for the node(s) of interest.

The personality of a workload is a characterization of the types of specialized resources that the workload utilizes from the various SERT-related (i.e., compute (CPU), and memory/storage capabilities. This data (as well as the LEED data) may be represented by respective vectors. For example, as shown in FIG. 2, a vector might include (for compute capabilities) an indication of one or more worklets of compress, cryptoAES, LU (lower-upper), SHA256, SOR (successive over-relaxation), SORT, and/or SSJ (server side Java), an indication of one or more worklets of FLOOD3 and CAPACITY3 (for memory capabilities), and an indication of one or more worklets of RANDOM and SEQUENTIAL (for storage capabilities).

Using this vector, and a LEED vector representative of LEED data, API sustainability rating logic 200 generates an API sustainability metric that is a normalized index that represents the efficiency of a node to service a particular workload.

Thus, for example, and qualitatively, a node that is powered with a renewable source will have a higher API sustainability metric compared to one without such a power source (with all else (e.g., SERT data) being comparatively the same).

By computing an API sustainability metric, it is possible to better steer an API workload to a set of node(s)/location(s) to reduce power utilization, and thus reduce an overall carbon footprint of a given workload.

In an embodiment, a “workload vector” is defined as a 16-bit number, where each bit represents a type of specialized operation that might be invoked by the workload in the order mentioned below. In this example, bits 12-16 are reserved for future expansion.
1. Compress
2. CryptoAES
3. LU
4. SHA256
5. SOR
6. SORT
7. SSJ
8. FLOOD3
9. CAPACITY3
10. RANDOM
11. SEQUENTIAL

A “runtime vector” may represent a current load of a given node, where it may be either a summarized value or an expanded value with the following elements:
1. Load CPU
2. Load Memory
3. Load Storage
4. Compress units
5. CryptoAES units
6. LU units
7. SHA256 units
8. SOR units
9. SORT units
10. SSJ units
11. FLOOD3 units
12. CAPACITY3 units
13. RANDOM units
14. SEQUENTIAL units

In an embodiment, data for elements 1-3 are indicative of basic usage of the given node's capabilities, and data for elements 4-14 may be provided for more granular information regarding existing workloads.

API sustainability rating logic 200 may operate as follows. For each potential node that is might be used by a given API a SERT vector and a LEED vector is received and loaded.

A Workload vector for the API is also loaded.

A Runtime vector for each device is loaded.

If elements 4-14 of the Runtime vector are not present, it may be assumed that the loads of elements 1, 2 and 3 are equally distributed across each of the sub-categories.

With the loaded data, API sustainability rating logic 200 computes the sustainability metric for each device per Workload vector, and may publish the same in the form of:
API Endpoint, Workload-type, Sustainability metric-(CPU, Memory, storage), Location

The sustainability metric can then be used as a basis for selecting where (i.e., which nodes) the given API should be executed. Selection may be manual or automatic. In some scenarios, it may be possible to split CPU, memory, and/or storage capabilities across multiple nodes.

The following is a simplified example of vectors and calculation of a sustainability metric. In this case a Workload vector might be: 00010000010, which corresponds to the following functions or capabilities: SHA256—to generate a hash, and RANDOM—for search.

A Runtime vector for a Node A is:
SHA256 (a)-50% (current load)-0.2 (SERT 2.0 efficiency score between 0 and 1)
RANDOM (b)-25% (current load)-0.6 (SERT 2.0 efficiency score between 0 and 1)

A LEED vector for Node A
Renewable energy (c)-0.5 (Score attributed to the energy source type (solar, coal, hydro))

Sustainability metric calculation for Node A: Geometric mean (a, b, c)=GM (0.2, 0.6, 0.5)=0.39

A Runtime vector for a NODE B is:
SHA256 (a)-50%-0.2 (same SERT score)
RANDOM (b)-25%-0.6 (same SERT score)

A LEED vector for Node B
Renewable energy (c)-0.01 (source of energy is coal)

Sustainability metric calculation for Node B: Geometric mean (a, b, c)=GM (0.2, 0.6, 0.01)=0.1

Based on the calculated sustainability metric for each of Node A and Node B, API sustainability rating logic 200 selects or recommends Node A over node B.

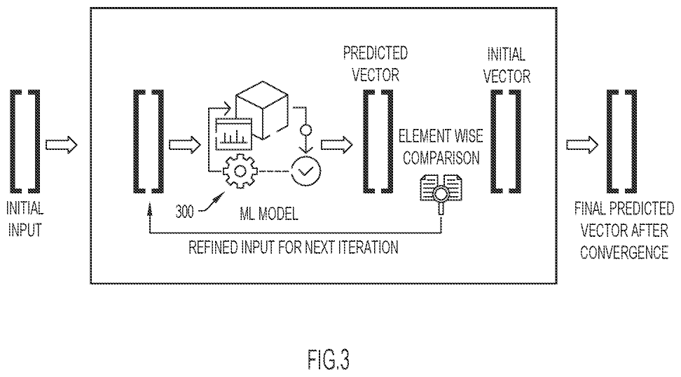

FIG. 3 illustrates the use of a machine learning approach that API sustainability rating logic 200 might employ to generate an API sustainability metric for an API, according to an example embodiment.

In an embodiment, an ML model 300 is initially trained using a labelled dataset made up of input vectors that represent the nodes' current state and corresponding output vectors that represent their efficiency. The baseline for the model's comprehension of the relationship between input and output is set by this initial training.

During the prediction stage, the model creates an output vector that represents the predicted efficiency for each node using an input vector that represents the node's current state.

The input vector is then updated for the following iteration using feedback from the predicted output vector. The corresponding element in the current input vector and each element in the expected output vector are compared. The value in the input vector stays the same if the anticipated efficiency is lower. The value in the input vector is updated to the predicted value if the estimated efficiency is higher than expected. The model receives the revised input vector and repeats the prediction stage. This iterative method continues until convergence requirements are satisfied, after a predetermined number of iterations. The change in the input vector or the expected output vector between iterations can be used to define the convergence criteria. For instance, the feedback loop can be halted, signifying that the model has reached a solution, if the change in the input and the predicted output vector, or the expected efficiencies fall below a specific level.

In situations where the model predicts a general level of efficiency for all nodes instead of specific values for each node, API sustainability rating logic 200 can employ a default case. This can be on the lines of calculating the average or median predicted efficiency value from the model's output vector and assigning this value as the efficiency for all server nodes.

By using this feedback loop, the ML model 300 iteratively refines its predictions and updates the input vector to improve the efficiency of the nodes. The ML model 300 leverages the learned relationship between the input and output vectors to generate increasingly accurate predictions and converges towards a desired efficiency configuration for the set of nodes.

As those skilled in the art will appreciate, the embodiments described herein are configured to calculate an API sustainability metric for different workloads based on a current Runtime vector, LEED data and SERT data for nodes used to execute a given API. The API sustainability metric can then be used to qualify servers to meet sustainability requirements.

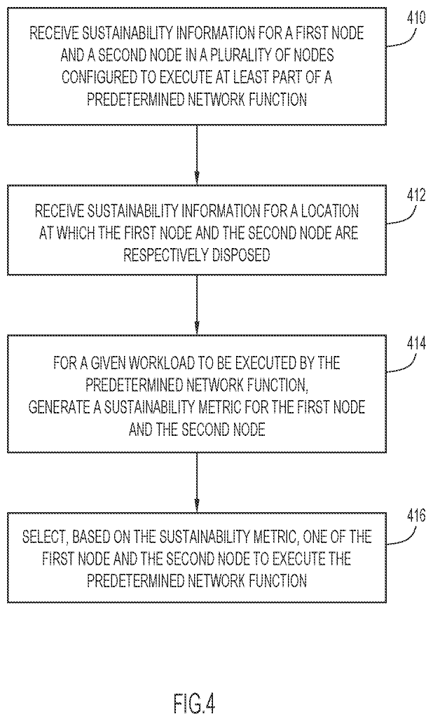

FIG. 4 is a flowchart illustrating a series of operations executed by API sustainability rating logic 200, according to an example embodiment. At 410, an operation includes receiving sustainability information for a first node and a second node in a plurality of nodes configured to execute at least part of a predetermined network function. At 412, an operation includes receiving sustainability information for a location at which the first node and the second node are respectively disposed. At 414, an operation includes for a given workload to be executed by the predetermined network function, generating a sustainability metric for the first node and the second node. And, at 416, an operation includes selecting, based on the sustainability metric, one of the first node and the second node to execute the predetermined network function.

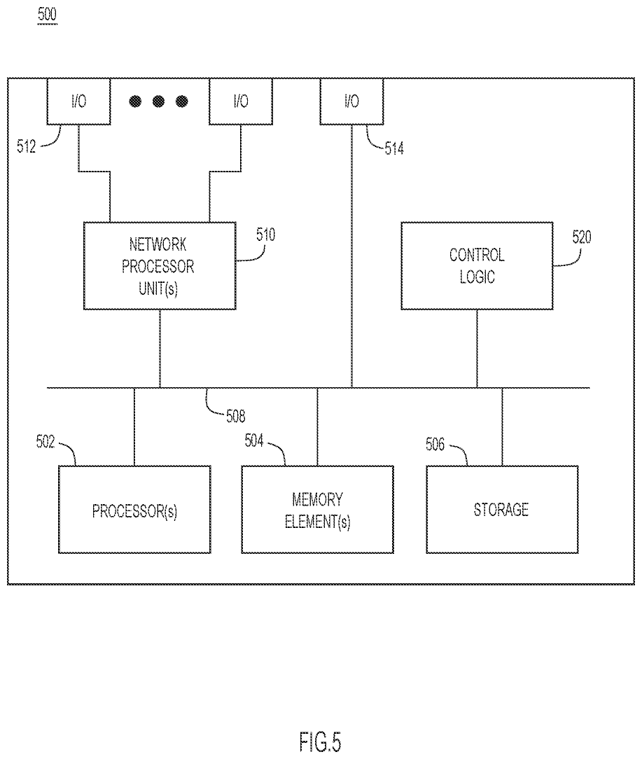

FIG. 5 is a block diagram of a computing device that may be configured to execute API sustainability rating logic 200 and perform the techniques described herein, according to an example embodiment. In various embodiments, a computing device, such as computing device 500 or any combination of computing devices 500, may be configured as any entity/entities as discussed for the techniques depicted in connection with FIGS. 1-4 in order to perform operations of the various techniques discussed herein.

In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O interface(s) 514, and control logic 520 (which could include, for example, API sustainability rating logic 200. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa) or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O interface(s) 514 allow for input and output of data and/or information with other entities that may be connected to computing device 500. For example, I/O interface(s) 514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In sum, a method may include receiving sustainability information for a first node and a second node in a plurality of nodes configured to execute at least part of a predetermined network function, receiving sustainability information for a location at which the first node and the second node are respectively disposed, for a given workload to be executed by the predetermined network function, generating a sustainability metric for the first node and the second node, and selecting, based on the sustainability metric, one of the first node and the second node to execute the predetermined network function.

In the method, the predetermined network function may be an application programming interface function.

In the method, receiving the sustainability information for the first node and the second node may include receiving information from a server efficiency rating tool (SERT) information source.

In the method, receiving sustainability information for the location at which the first node and the second node are respectively disposed may include receiving information from a leadership in energy and environmental design (LEED) information source.

In the method, generating the sustainability metric for the first node and the second node may include receiving runtime information for the first node and the second node.

In the method, generating the sustainability metric for the first node and the second node may include receiving workload information for the predetermined network function.

In the method, generating the sustainability metric for the first node and the second node may include generating a geometric mean of the sustainability information for the first node and the second node and the sustainability information for the location at which the first node and the second node are respectively disposed.

The method may further include automatically selecting the one of the first node and the second node to execute the predetermined network function.

In the method, generating the sustainability metric for the first node and the second node may include using machine learning.

The method may further include publishing the sustainability metric for the first node and the second node.

In another embodiment, a device may be provided and may include an interface configured to enable network communications, a memory, and one or more processors coupled to the interface and the memory, and configured to: receive sustainability information for a first node and a second node in a plurality of nodes configured to execute at least part of a predetermined network function, receive sustainability information for a location at which the first node and the second node are respectively disposed, for a given workload to be executed by the predetermined network function, generate a sustainability metric for the first node and the second node, and select, based on the sustainability metric, one of the first node and the second node to execute the predetermined network function.

In the device, the predetermined network function may be an application programming interface function.

In the device, the one or more processors may be further configured to receive the sustainability information for the first node and the second node by receiving information from a server efficiency rating tool (SERT) information source.

In the device, the one or more processors may be further configured to receive sustainability information for the location at which the first node and the second node are respectively disposed by receiving information from a leadership in energy and environmental design (LEED) information source.

In the device, the one or more processors may be further configured to generate the sustainability metric for the first node and the second node by receiving runtime information for the first node and the second node.

In the device, the one or more processors may be further configured to generate the sustainability metric for the first node and the second node by receiving workload information for the predetermined network function.

In the device, the one or more processors may be further configured to generate the sustainability metric for the first node and the second node by generating a geometric mean of the sustainability information for the first node and the second node and the sustainability information for the location at which the first node and the second node are respectively disposed.

In yet another embodiment, one or more non-transitory computer readable storage media encoded with instructions are provided and that, when executed by a processor, cause the processor to: receive sustainability information for a first node and a second node in a plurality of nodes configured to execute at least part of a predetermined network function, receive sustainability information for a location at which the first node and the second node are respectively disposed, for a given workload to be executed by the predetermined network function, generate a sustainability metric for the first node and the second node, and select, based on the sustainability metric, one of the first node and the second node to execute the predetermined network function.

The one or more non-transitory computer readable storage media may also include instructions that are configured to receive the sustainability information for the first node and the second node by receiving information from a server efficiency rating tool (SERT) information source.

The one or more non-transitory computer readable storage media may also include instructions that are configured to receive sustainability information for the location at which the first node and the second node are respectively disposed by receiving information from a leadership in energy and environmental design (LEED) information source.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
receiving sustainability information for a first node and a second node in a plurality of nodes configured to execute at least part of a predetermined network function;
receiving sustainability information for a location at which the first node and the second node are respectively disposed;
for a given workload to be executed by the predetermined network function, generating a sustainability metric for the first node and the second node; and
selecting, based on the sustainability metric, one of the first node and the second node to execute the predetermined network function.

2. The method of claim 1, wherein the predetermined network function is an application programming interface function.

3. The method of claim 1, wherein receiving the sustainability information for the first node and the second node comprises receiving information from a server efficiency rating tool (SERT) information source.

4. The method of claim 1, wherein receiving sustainability information for the location at which the first node and the second node are respectively disposed comprises receiving information from a leadership in energy and environmental design (LEED) information source.

5. The method of claim 1, wherein generating the sustainability metric for the first node and the second node comprises receiving runtime information for the first node and the second node.

6. The method of claim 1, wherein generating the sustainability metric for the first node and the second node comprises receiving workload information for the predetermined network function.

7. The method of claim 1, wherein generating the sustainability metric for the first node and the second node comprises generating a geometric mean of the sustainability information for the first node and the second node and the sustainability information for the location at which the first node and the second node are respectively disposed.

8. The method of claim 1, further comprising automatically selecting the one of the first node and the second node to execute the predetermined network function.

9. The method of claim 8, wherein generating the sustainability metric for the first node and the second node comprises using machine learning.

10. The method of claim 1, further comprising publishing the sustainability metric for the first node and the second node.

11. A device comprising:
an interface configured to enable network communications;
a memory; and
one or more processors coupled to the interface and the memory, and configured to:
receive sustainability information for a first node and a second node in a plurality of nodes configured to execute at least part of a predetermined network function;
receive sustainability information for a location at which the first node and the second node are respectively disposed;
for a given workload to be executed by the predetermined network function, generate a sustainability metric for the first node and the second node; and
select, based on the sustainability metric, one of the first node and the second node to execute the predetermined network function.

12. The device of claim 11, wherein the predetermined network function is an application programming interface function.

13. The device of claim 11, wherein the one or more processors are further configured to receive the sustainability information for the first node and the second node by receiving information from a server efficiency rating tool (SERT) information source.

14. The device of claim 11, wherein the one or more processors are further configured to receive sustainability information for the location at which the first node and the second node are respectively disposed by receiving information from a leadership in energy and environmental design (LEED) information source.

15. The device of claim 11, wherein the one or more processors are further configured to generate the sustainability metric for the first node and the second node by receiving runtime information for the first node and the second node.

16. The device of claim 11, wherein the one or more processors are further configured to generate the sustainability metric for the first node and the second node by receiving workload information for the predetermined network function.

17. The device of claim 11, wherein the one or more processors are further configured to generate the sustainability metric for the first node and the second node by generating a geometric mean of the sustainability information for the first node and the second node and the sustainability information for the location at which the first node and the second node are respectively disposed.

18. One or more non-transitory computer readable storage media encoded with instructions that, when executed by a processor, cause the processor to:
receive sustainability information for a first node and a second node in a plurality of nodes configured to execute at least part of a predetermined network function;
receive sustainability information for a location at which the first node and the second node are respectively disposed;
for a given workload to be executed by the predetermined network function, generate a sustainability metric for the first node and the second node; and
select, based on the sustainability metric, one of the first node and the second node to execute the predetermined network function.

19. The one or more non-transitory computer readable storage media of claim 18, wherein the instructions are configured to receive the sustainability information for the first node and the second node by receiving information from a server efficiency rating tool (SERT) information source.

20. The one or more non-transitory computer readable storage media of claim 18, wherein the instructions are configured to receive sustainability information for the location at which the first node and the second node are respectively disposed by receiving information from a leadership in energy and environmental design (LEED) information source.
